(19) United States
(12) Patent Application Publication
(10) Pub. No.: US 2016/0314534 A1
(43) Pub. Date: Oct. 27, 2016

(54) REAL-TIME REHYPE

(71) Applicant: THE BANK OF NEW YORK MELLON, New York, NY (US)

(72) Inventor: Brian BLANK, Manalapan, NJ (US)

(21) Appl. No.: 15/136,596

(22) Filed: Apr. 22, 2016

Related U.S. Application Data
(60) Provisional application No. 62/151,247, filed on Apr. 22, 2015.

(51) Int. Cl. G06Q 40/06

(52) U.S. Cl. CPC G06Q 40/06

(57) ABSTRACT

A method for real-time rehype is described. The method being implemented on a computer system having one or more physical processors programmed with computer program instructions which, when executed, perform the method. The method comprising allocating a real-time rehype position to an investor; pending, by the computer system, the position into a dealer box of the investor; determining, by the computer system, the liquidity of the investor; in response to the investor having insufficient liquidity, continue pending the position into a dealer box; and in response to the investor having sufficient liquidity, settling the position with the investor.

This application claims priority to U.S. Provisional Patent Application No. 62/151,247 filed on Apr. 22, 2015, which is incorporated by reference herein in its entirety.

This application is related to U.S. patent application Ser. No. 13/894,991, which claims benefit to U.S. Provisional Patent Application Ser. No. 61/647,346. This application is also related to U.S. patent application Ser. No. 13/362,980, which claims benefit to U.S. Provisional Application Ser. No. 61/438,195. This application is also related to U.S. patent application Ser. No. 13/362,980, which claims benefit to U.S. Provisional Application Ser. No. 61/438,195. This application is further related to U.S. patent application Ser. No. 14/137,441 which claims benefit to U.S. Provisional Patent Application 61/745,187. This application is also related to U.S. patent application Ser. No. 14/146,390, which claims benefit to U.S. Provisional Application Ser. No. 61/748,633. Each of the above mentioned applications is incorporated herein in its entirety by reference.

### FIELD OF THE INVENTION

The invention relates to a computer-implemented system and method for settling Repurchase Agreements (“Repos”). It finds particular application in determining the investor's available liquidity to purchase the collateral from the dealer and settling Tri-Party Repos based on the investor's available liquidity and will be described with particular reference thereto.

### BACKGROUND OF THE INVENTION

In a Repo, a seller (dealer/borrower/cash receiver) sells securities for cash to a buyer (lender/cash provider) and agrees to repurchase those securities at a later date for more cash. The Repo rate is the difference between borrowed and paid back cash expressed as a percentage. The buyer typically utilizes Repos to invest cash for an agreed upon duration of time (typically overnight, although the term may vary), and would receive a rate of interest in return for the investment. The seller typically utilizes Repos to finance long positions in securities or other assets in the seller's portfolio.

Repos are financial instruments used in money markets and capital markets, and are economically similar to a secured loan, with the buyer receiving securities as collateral to protect against default. Virtually any security may be employed in a Repo, including, for example, Treasury or Government bills, corporate and Treasury/Government bonds, stocks/shares, or other securities or financial instruments. In a Repo, however, the legal title to the securities clearly passes from the seller to the buyer, or “investor”. Coupons (installment payments that are payable to the owner of the securities), which are paid while the Repo buyer owns the securities are, in fact, usually passed directly onto the Repo seller. This may seem counterintuitive, as the ownership of the collateral technically rests with the buyer during the Repo agreement. It is possible to instead pass on the coupon by altering the cash paid at the end of the agreement, though this is more typical of Sell/Buy Backs.

Although the underlying nature of a Repo transaction is that of a loan, the terminology differs from that used when talking of loans because the seller does actually repurchase the legal ownership of the securities from the buyer at the end of the agreement. Although the actual effect of the whole transaction is identical to a cash loan, in using the “repurchase” terminology, the emphasis is placed upon the current legal ownership of the collateral securities by the respective parties.

In a Tri-Party Repo, the collateral is managed by a Tri-Party dealer (typically a bank), who may match the details of the trade agreed upon by the buyer and the seller, and assumes all of the post trade processing and settlement work (e.g., acting as a clearinghouse). The Tri-Party dealer controls the movement of securities, such that the buyers do not actually take delivery of collateralized securities. The Tri-Party dealer acts as a custodian for the collateral, and allows the flow of collateral and cash between buyers and sellers across one or more deals.

A clearinghouse (e.g., the Tri-Party dealer in some embodiments) may provide liquidity to dealers, who borrow funds from the clearinghouse to unwind maturing deals and obtain funds from new investors to pay back the clearinghouse. As described in U.S. patent application Ser. No. 13/894,991, incorporated above in its entirety by reference, this process conventionally involves a large credit component, such as an intraday credit, that a clearinghouse injects into the system to unwind deals of the day. For example, at the maturity time in the industry, trades are matured, or unwound, and a subset of all the tri-party trades matures. For a deal to mature, the dealer of the trade pays the investor. Specifically, the dealers pay off or repurchase the securities for the maturing deals. The maturing parties quite often have in new deals that are put out. The clearinghouse generally provides cash to the investors and thus may pay the investors on behalf of the dealer and debit the dealers' accounts en masse. Thus, every maturing trade gets paid all at the same time at the maturity time. The clearinghouse then returns the collateral, such as securities, from the investor back to the dealer's account.

Because there is a chance the dealer will be unable to pay back the clearinghouse, the unwinding process exposes the clearinghouse to risk in the period between unwinding of existing trades and reallocation and settlement of new trades. Reallocation and settlement of the new trades extinguishes the exposure to independent events, however presently a time gap of exposure occurs in the minutes or up to several hours before the new trades settle.

Further, this risk is amplified in rehypothecated trades. These trades are special in that the collateral that is sold from dealer A to investor A can also be resold to investor B if investor A is also a dealer. Investors are traditionally mutual funds or money market funds, but also a broker-dealer can act as an investor in rehyped trades. Therefore, in this case investor A is also a broker-dealer and then can resell the collateral ‘downstream’ to another investor. This can happen many ‘legs’ in a rehypethocated chain and thus exposes the clearinghouse to further risk in the period between unwinding of existing trades and reallocation and settlement of rehyped trades.

### SUMMARY OF THE INVENTION

Through various embodiments described herein, the system and method of this disclosure enhances settlement associated with a plurality of Repo agreements. Various embodiments of this disclosure may be used in conjunction with existing financial services platforms, for example the Bank of New York Mellon's Tri-Party repurchase agreement products (RepoEdge®) which allow clients to outsource the operational aspects of their collateralized transactions, and Derivatives Margin Management (DM Edge®), which helps clients manage credit risks associated with derivatives transactions by enabling them to accept, monitor and re-transfer collateral. These services, among others such as Repo Margin Management (RM Edge®), MarginDirect^{SM}, and Derivatives Collateral Net (DCN), may be delivered to clients through AccessEdge^{SM}, a real-time, web-based portal.

The invention relates to a real-time rehype trade settlement process. The real-time rehype trade settlement process may include delivering allocated collateral in a pending deliver position (pending Delivery versus Payment [DVP]) from the dealer and copying the collateral to the investor as a pending receive position (pending Receive versus Payment [RVP]). The investor may allocate the pending receive position to their trade, prior to incremental settlement occurring. The settlement for the dealer's pending DVP and investor's pending RVP incrementally pends or settles the trade based on the investor's available liquidity. In one implementation, the settlement may be based on the investor's available liquidity to purchase the collateral from the dealer. In the event the investor does not have sufficient available liquidity, the investor may increase their liquidity by relying on funding from their real-time rehype DVP trade. Upon settlement of their DVP trade, the DVP trade proceeds can be used by the investor to offset their collateral purchase from the dealer. The investor may also increase liquidity by relying on auto cash credit received from a second leg investor trade. The investor may reallocate a pending receive position to their real-time rehype RVP trade, which will then trigger the return of their auto cash credit. The auto cash credit can be used to offset the collateral purchase from the dealer. The investor may further increase liquidity by relying on the real-time rehype NFE credit that was provided to the investor from the dealer's recall on the purchased collateral. Upon reallocation of the collateral by the dealer, the real-time rehype NFE credit of the investor can be used to offset the collateral purchase.

The real-time rehype settlement process provides the advantage of aligning general collateral finance trades and all other real-time rehype trade processes with DVP/RVP trades. Further, the rehype settlement process provides settlement between the dealer and the investor in real-time. Use of a dealer's available liquidity to enforce the monitoring of the purchase of securities by investors of Real-Time rehype collateral also reduces the risk associated with settlement such as RVP exposure. Investors also have the benefit of no longer being exposed to intraday cash allocation until incremental settlement occurs and may monitor pending securities allocated to their trades.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a high level flowchart of the allocation of a pending rehypothecation position, according to an implementation of the invention.

FIG. 2 illustrates a high level flowchart of operation of the real-time rehype settlement process, according to an implementation of the invention.

FIG. 3 illustrates a system of real-time rehype settlement, according to an implementation of the invention.

FIG. 4 Illustrates an exemplary process of the incremental settlement of a real-time rehype trade, according to an implementation of the invention.

FIG. 5 illustrates an exemplary process of allocation of a pending real-time rehype position, according to an implementation of the invention.

FIGS. 6A and 6B illustrate an exemplary process of settlement flow of an investor's purchase of real-time rehype collateral using their available liquidity, according to an implementation of the invention.

FIGS. 7A and 7B illustrate an exemplary process of the settlement flow of a dealer's purchase of rehype collateral using liquidity from an investor's available cash, according to an implementation of the invention.

FIGS. 8A and 8B illustrate an exemplary process of the settlement flow of the dealer's purchase of real-time rehype collateral using liquidity from an investor's auto cash, according to an implementation of the invention.

FIG. 9 illustrates an exemplary process of the settlement flow of a real-time rehype collateral purchase on a reallocation of collateral, according to an implementation of the invention.

FIG. 10 illustrates an exemplary process of settling a real-time rehype collateral purchase through retry using the investor's available liquidity, according to an implementation of the invention.

FIG. 11 illustrates an exemplary table of criteria required to validate certain types of trades, according to an implementation of the invention.

### DETAILED DESCRIPTION OF THE INVENTION

The invention relates to settling repurchase agreements based on an investor's available liquidity to purchase the collateral from the dealer. The real-time rehype trade settlement process may include delivering allocated collateral in a pending deliver position (pending Delivery versus Payment [DVP]) from the dealer and copying the collateral to the investor as a pending receive position (pending Receive versus Payment [RVP]). The investor may allocate the pending receive position to their trade, prior to incremental settlement occurring. The settlement for the dealer's pending DVP and investor's pending RVP incrementally pends or settles the trade based on the investor's available liquidity. In one implementation, the settlement may be based on the investor's available liquidity to purchase the collateral from the dealer. In the event the investor does not have sufficient available liquidity, the investor may increase their liquidity by relying on funding from their real-time rehype DVP trade. Upon settlement of their DVP trade, the DVP trade proceeds can be used by the investor to offset their collateral purchase from the dealer.

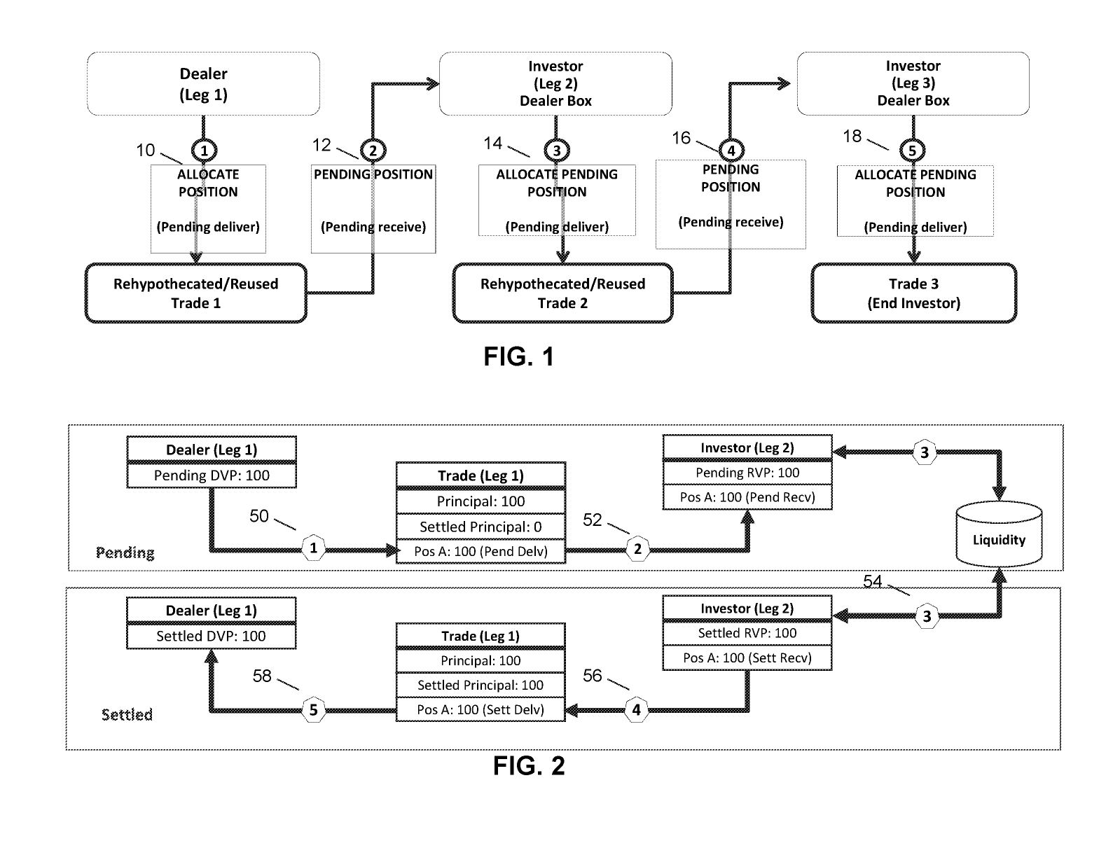

Rehypothecation or rehype is the ability to re-use assets that one has received as collateral against an obligation of one's own. Rehypothecation is standard practice in the bilateral market. For example, two parties A and B have a relationship where A acts as the investor and B as the dealer. A delivers collateral to B to meet an obligation against borrowed cash or stock. B then re-uses, or rehypothecates, the collateral to satisfy its own obligation with C. C performs the same exercise as B, satisfying an obligation with D. D is the final lender in the ‘rehypothecation chain’. This concept can be extended, with multiple re-use branches across many different counterparties. FIG. 1 illustrates a high level flowchart of the allocation of a pending rehypothecation position. It may be appreciated that the order of the steps listed may be merely exemplary, and in some implementations, one or more steps of the operation may occur in a different order than illustrated, or may occur in conjunction with one another. In a step 10, a sealer (Leg 1) allocates a real-time rehype position to their Investor. The system pends (copies) the position to the Investor (Leg 2). This trade is represented as a pending deliver to the Investor (Leg 2). In a step 12, upon allocation of the pending (copied) position from the sealer (Leg 1), the Investor (Leg 2) receives the pending (copied) position into its dealer box as a pending receive. In a step 14, the investor (Leg 2) allocates the pending (copied) position to their investor (Leg 3). Upon allocation of the pending (copied) position from the investor (Leg 2), in a step 16, the investor (Leg 3) receives the pending (copied) position to its dealer box as a pending receive. In a step 18, the investor (Leg 3) allocates the pending (copied) position to their investor (End Investor).

FIG. 2 illustrates a high level flowchart of operation 10 of the real-time rehype trade settlement process which may be implemented by a computer system (e.g. those maintained at a clearinghouse, or otherwise associated with the Tri-Party dealer). It may be appreciated that the order of the steps listed may be merely exemplary, and in some implementations, one or more steps of the operation may occur in a different order than illustrated, or may occur in conjunction with one another. In an operation 50, for a new Trade (Leg 1), the dealer (Leg 1) allocates a real-time rehype position to their investor (Leg 2). In an operation 52, the system pends (copies) the position into the dealer box of the Investor (Leg 2). In a step 54, the system checks for available liquidity of the Investor (Leg 2). If the investor (Leg 2) has insufficient available liquidity, the settlement will remain in a pending state. In a step 56, if the investor (Leg 2) has sufficient available liquidity, then the position settles to this Investor's dealer box and the pending RVP settles. In a step 58, the Pending DVP of the Dealer (Leg 1) then settles.

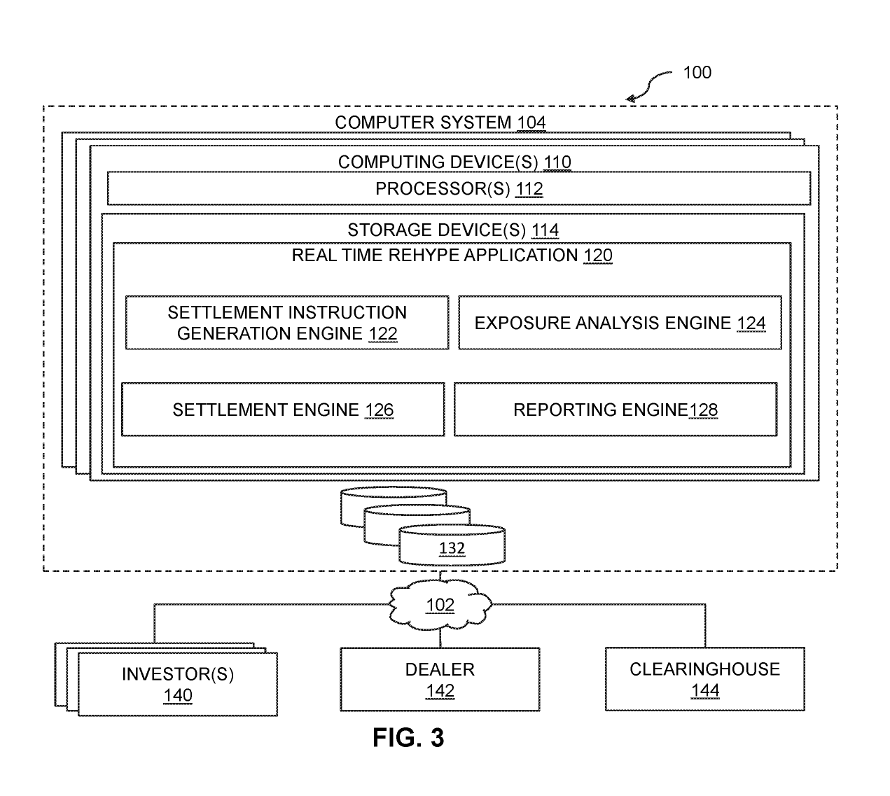

FIG. 3 illustrates a configuration of a high-level system 100 of a real-time rehype trade settlement system, according to an implementation of the invention. The system 100 may settlement collateral of a Tri-Party Repo based on an investor's available liquidity to purchase the collateral from the dealer and settling Tri-Party Repos based on the investor's available liquidity and will be described with particular reference thereto.

Various examples used herein throughout may refer to examples of the real-time rehype trade settlement process system, although other uses and implementations of the system are contemplated and will be apparent to those having skill in the art using the disclosure herein. Having described a high level overview of some of the system functions, attention will now be turned to various system components that facilitate these and other functions.

### System Components

System 100 may include a computer system 104, one or more databases 132, one or more investors 140, a dealer 142, a clearinghouse 144, and/or other components. In some implementation, the clearinghouse 144 may be the Tri-Party dealer 142.

To facilitate these and other functions, computer system 104 may include one or more computing devices 110. Each computing device 110 may include one or more processors 112, one or more storage devices 114, and/or other components.

Processor(s) 112 may be programmed by one or more computer program instructions, which may be stored in storage device(s) 114. The one or more computer program instructions may include, without limitation, real-time rehype application 120. Real-time rehype application 120 may itself include different sets of instructions that each program the processor(s) 112 (and therefore computer system 104). For example, real-time rehype application 120 may include a trade allocation engine 122, an exposure analysis engine 124, a settlement engine 126, a reporting engine 128, and/or other instructions that program computer system 104. As used herein, for convenience, the various instructions will be described as performing an operation, when, in fact, the various instructions program computer system 104 to perform the operation.

Operation of Real-Time Rehype Settlement System

In one implementation, the real-time rehype trade settlement system may settlement collateral of a Tri-Party Repo based on an investor's available liquidity to purchase the collateral from the dealer and settling Tri-Party Repos based on the investor's available liquidity and will be described with particular reference thereto. In one implementation, in rehypothecation trading, the real-time rehype trade settlement system may include delivering allocated collateral in a pending deliver position (pending Delivery versus Payment [DVP]) from the dealer and copying the collateral to the investor as a pending receive position (pending Receive versus Payment [RVP]). The investor may allocate the pending receive position to their trade, prior to incremental settlement occurring. The settlement for the dealer's pending DVP and investor's pending RVP incrementally pends or settles the trade based on the investor's available liquidity. In one implementation, the settlement may be based on the investor's available liquidity to purchase the collateral from the dealer.

For example, in a new rehype trade, the dealer may allocate a real-time rehype position to their investor. The system pends (copies) the position into the dealer box of the investor. The system may check for available liquidity of the Investor to determine whether to settlement the trade or not. If the investor has insufficient available liquidity, the settlement will remain in a pending state. However, if the investor has sufficient available liquidity, then the position settles to this investor's dealer box and the pending trade settles.

Allocating and Pending Positions

In one implementation, a trade allocation engine may allocate a real-time rehype position to their investor. In response to allocating the real-time rehype position, the trade allocation engine pends (copies) the position into the dealer box of the investor. Thus, the trade is put in a pending state and not settled until a determination of the investor liquidity is complete. In other words, all trades are given a pending status until a determination that the investor liquidity is sufficient to settle the position.

Exposure Limit and Analysis

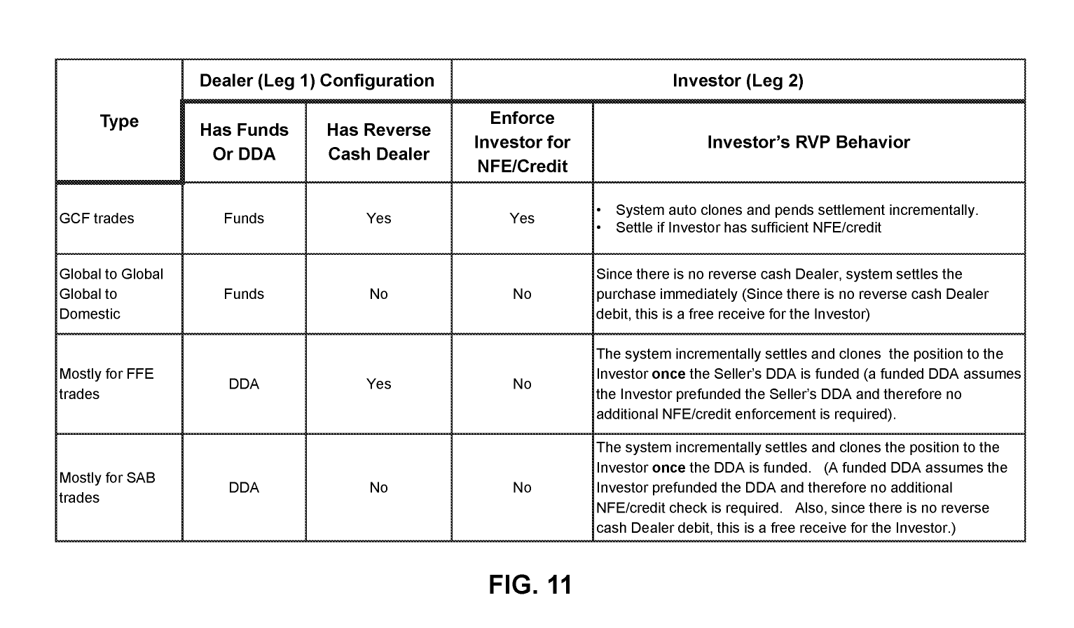

In one implementation, exposure analysis engine analyzes the liquidity of the investor to determine has sufficient available liquidity to settle the position. In other words, exposure analysis engine may check for available liquidity of the Investor to determine whether to settlement the trade or not. In on implementation, the exposure analysis engine analyzes certain criteria to determine if the Investor can settle the trade without a credit check being performed (in the interim or target states). For example, as shown in the table of FIG. 11, certain criteria must be validated for certain types of trades. In one implementation, the exposure analysis engine determines whether the investor to determine has sufficient available liquidity to settle the position. For example, the exposure analysis engine may determine that a certain investor has sufficient available liquidity if the investor has liquidity to cover the entire position. In another implementation, sufficient liquidity may be determined if only a predetermined threshold (i.e. 75%) of liquidity if available to cover the position. In one implementation, the exposure limits may be set by the user via a user interface. For example, the exposure analysis engine may analyze the available liquidity of the investor based on customized exposure limits.

Settlement of a Rehype Trade

In one implementation, settlement engine may settle the rehype position pending in the dealer box. For example, it is determined that the investor has sufficient available liquidity based on the exposure analysis, the position settles to this investor's dealer box and the pending trade settles. If the investor does not have sufficient available liquidity, the position is not settled with the investor and remains in a pending state.

Retrying a Pending Purchase Request

In one implementation, the settlement engine may perform a retry process. In one implementation, if an investor has zero NFE/available liquidity, the settlement engine will pend the position and will wait for the investor's NFE/available liquidity to increase. In another implementation, the settlement engine may check, at regular intervals, for the investor's NFE/available liquidity to determine if it is sufficient to settle the position. Based on the amount to settle (Auto Cash/settlement cash), if the NFE/available liquidity of the investor is sufficient, the position will be settled. In another implementation, the settlement engine may perform this for each leg of the Real-Time rehype trade independently of the position settlement status of upstream or downstream leg. In another implementation, the settlement engine may continue to perform retries until all the Pending positions are settled. If the investor does not have sufficient NFE/available liquidity to purchase the pending positions from multiple dealers at the same time, the settlement engine may prioritize the settlement of the pending positions based on the allocation order.

Include/Exclude Pending Allocations or Rebalancing

If there is a position that has both pending and settled status, settlement engine may allocate the settled position first, and then allocate the pend position as needed. This applies to the non-settlement Continuous Portfolio Optimization (CPO) allocations. If there are both pending and settled positions in either dealer box or trade or both, any substitution request through CPO/Rebalancing/Release request will always release pending positions first and then the settled positions, since pending positions are treated like excess collateral. For rebalancing in Clone to Projected Mode, pending rehypothecated positions will always be included in the settlement engine by default.

Reporting Engine

In one implementation, a reporting engine may provide a report displaying the positions that are completed, pending, and/or failed. The report may be displayed on a user interface of the computer system and utilized to clean up the process for settlement completion.

Insufficient Liquidity

In the event the investor does not have sufficient available liquidity, the investor may increase their liquidity by relying on funding from their real-time rehype DVP trade. Upon settlement of their DVP trade, the DVP trade proceeds can be used by the investor to offset their collateral purchase from the dealer. The investor may also increase liquidity by relying on auto cash credit received from a second leg investor trade. The investor may reallocate a pending receive position to their real-time rehype RVP trade, which will then trigger the return of their auto cash credit. The auto cash credit can be used to offset the collateral purchase from the dealer. The investor may further increase liquidity by relying on the real-time rehype NFE credit that was provided to the investor from the dealer's recall on the purchased collateral. Upon reallocation of the collateral by the dealer, the real-time rehype NFE credit of the investor can be used to offset the collateral purchase.

Net Free Equity Impact

In an implementation, the pending real-time rehype trade settlement may have an effect on the net free equity (NFE). For example, when there is a Pending deliver for the dealer: the dealer retains the NFE value of the position allocated to the trade, the dealer does not receive an Auto Cash credit because the position allocated has a Pending deliver status, and if there is Auto Cash in the trade, then the Auto Cash will remain in the investor's trade. When there is a pending receive for the investor: the investor maintains the Real-Time Rehypothecated/Reused NFE credit, and the investor's NFE value does not increase due to the Pending position in the dealer box. When the investor allocates a Pending receive position to their trade and there is: no Auto Cash in the trade, then the investor's NFE value does not change, and Auto Cash in the trade, then the Auto Cash can be used by the investor to support the collateral purchase. This will settle the Pending position, and the investor will receive an Auto Cash credit, which will increase their NFE value.

Examples of System Architectures and Configurations

Different system architectures may be used. For example, all or a portion of real-time rehype application 120 may be executed on a server device. In other words, computing device 110 as illustrated may include a server device that obtains a user request from a user device operated by the user. In implementations where all or a portion of real-time rehype application 120 is executed on the server device, the server device may perform the functionality of the real-time rehype application 120.

Although illustrated in FIG. 1 as a single component, computer system 104 may include a plurality of individual components (e.g., computer devices) each programmed with at least some of the functions described herein. In this manner, some components of computer system 104 may perform some functions while other components may perform other functions, as would be appreciated. The one or more processors 112 may each include one or more physical processors that are programmed by computer program instructions. The various instructions described herein are exemplary only. Other configurations and numbers of instructions may be used, so long as the processor(s) 112 are programmed to perform the functions described herein.

Furthermore, it should be appreciated that although the various instructions are illustrated in FIG. 1 as being co-located within a single processing unit, in implementations in which processor(s) 112 includes multiple processing units, one or more instructions may be executed remotely from the other instructions.

The description of the functionality provided by the different instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, processor(s) 112 may be programmed by one or more additional instructions that may perform some or all of the functionality attributed herein to one of the instructions.

The various instructions described herein may be stored in a storage device 114, which may comprise random access memory (RAM), read only memory (ROM), and/or other memory. The storage device may store the computer program instructions (e.g., the aforementioned instructions) to be executed by processor 112 as well as data that may be manipulated by processor 112. The storage device may comprise floppy disks, hard disks, optical disks, tapes, or other storage media for storing computer-executable instructions and/or data.

The various components illustrated in FIG. 1 may be coupled to at least one other component via a network, which may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. In FIG. 1 and other drawing Figures, different numbers of entities than depicted may be used. Furthermore, according to various implementations, the components described herein may be implemented in hardware and/or software that configure hardware.

The various databases 160 described herein may be, include, or interface to, for example, an Oracle™ relational database sold commercially by Oracle Corporation. Other databases, such as Informix™, DB2 (Database 2) or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may store a plurality of types of data and/or files and associated data or file descriptions, administrative information, or any other data.

Exemplary Illustrations

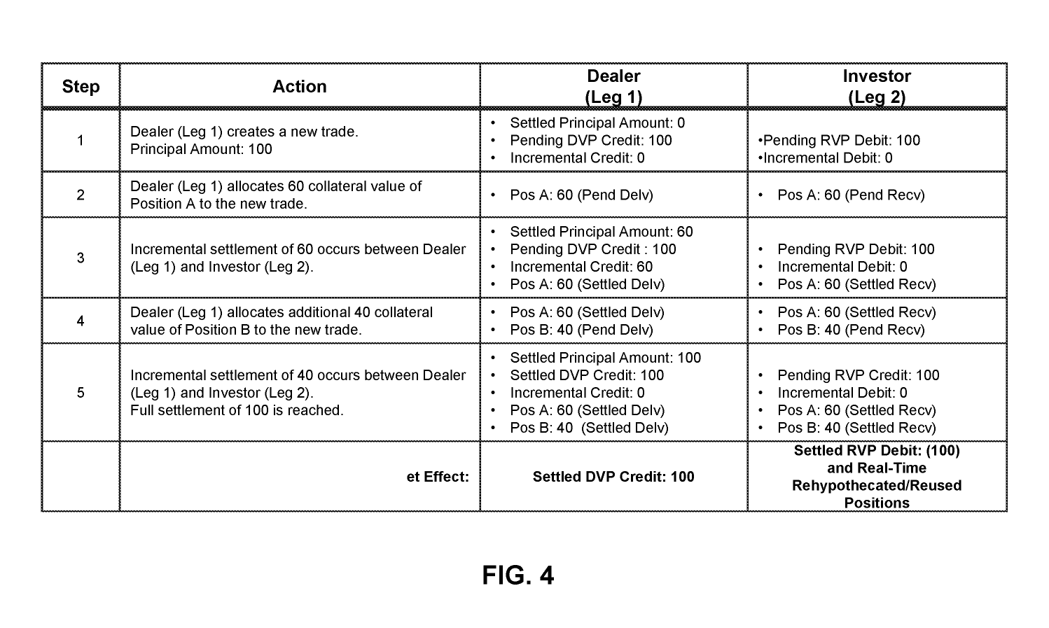

FIG. 4. Illustrates an exemplary process of the incremental settlement of a real-time rehype trade. As described in FIG. 4, when a dealer's real-time rehype DVP trade is incrementally settled, the investor's purchase will also incrementally settle. Both the investor and the dealer will then see the incremental fields updated in the following system window or screens, as incremental settlement occurs.

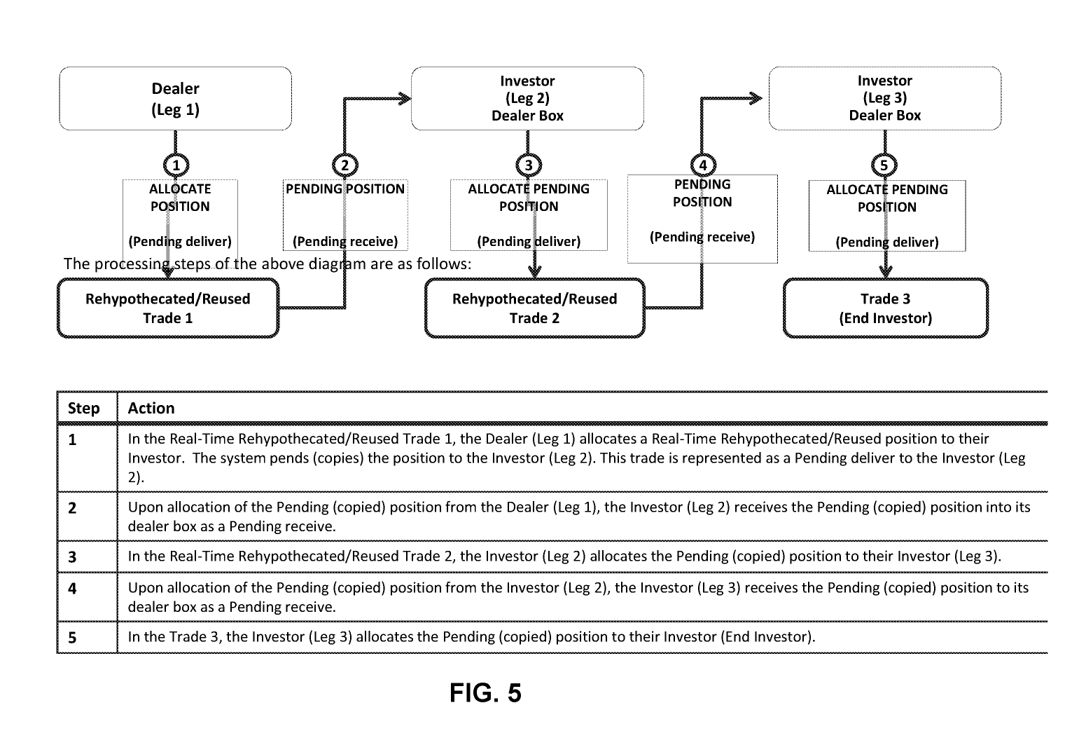

FIG. 5 illustrates an exemplary process of allocation of a pending real-time rehype position.

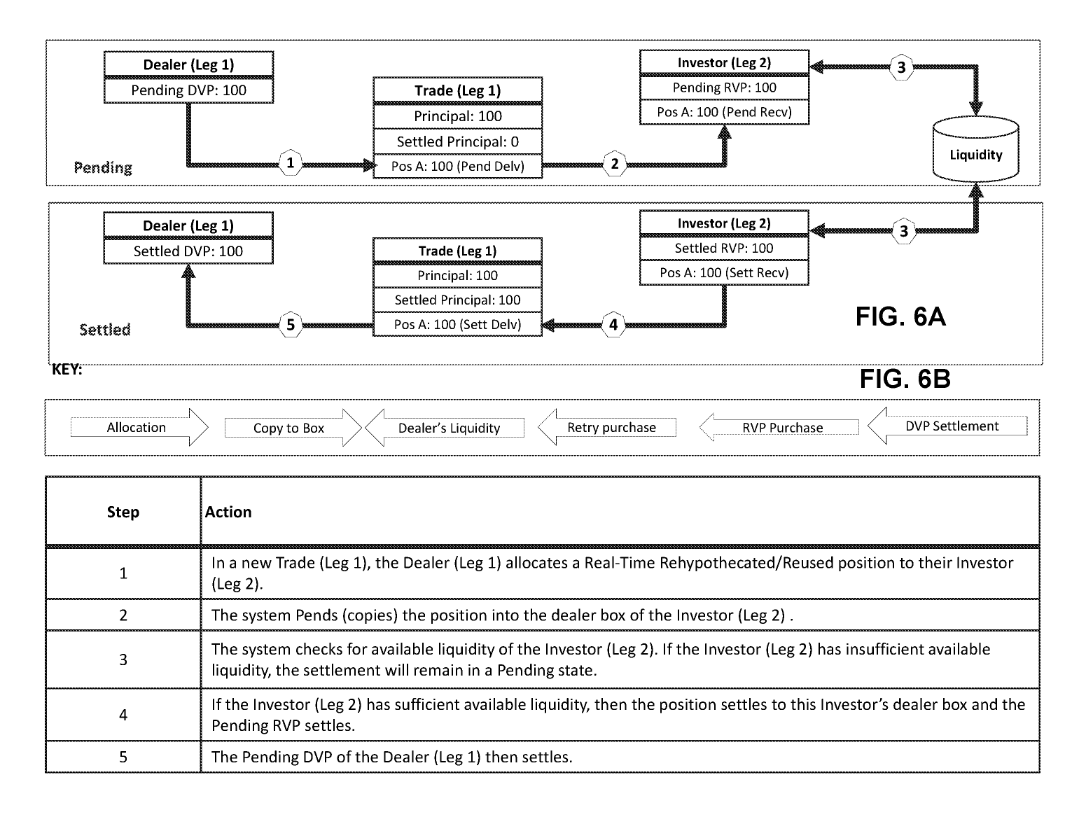

FIGS. 6A and 6B illustrate an exemplary process of settlement flow of an investor's purchase of real-time rehype collateral using their available liquidity.

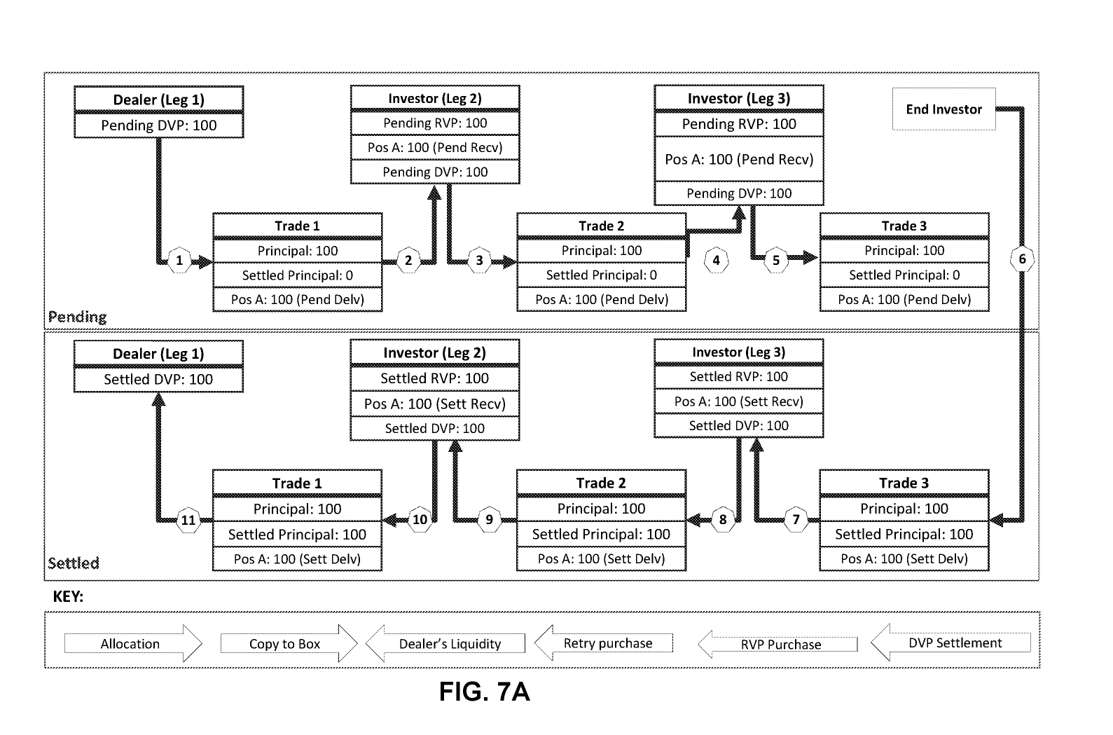

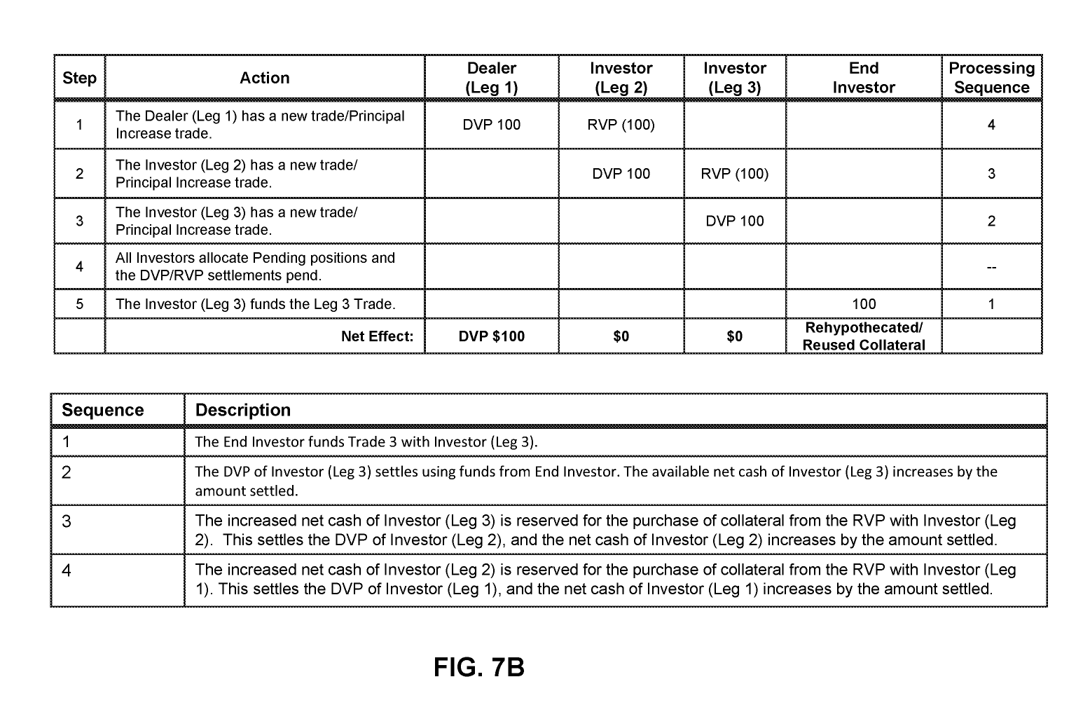

FIGS. 7A and 7B illustrate an exemplary process of the settlement flow of a dealer's purchase of rehype collateral using liquidity from an investor's available cash. The funding received from the end investor increases the investor's available liquidity throughout the chain of the legs of the real-time rehype trade. This increased liquidity may be used to fund the settlement for the upstream investors, resulting in the settlement of the dealer's trade.

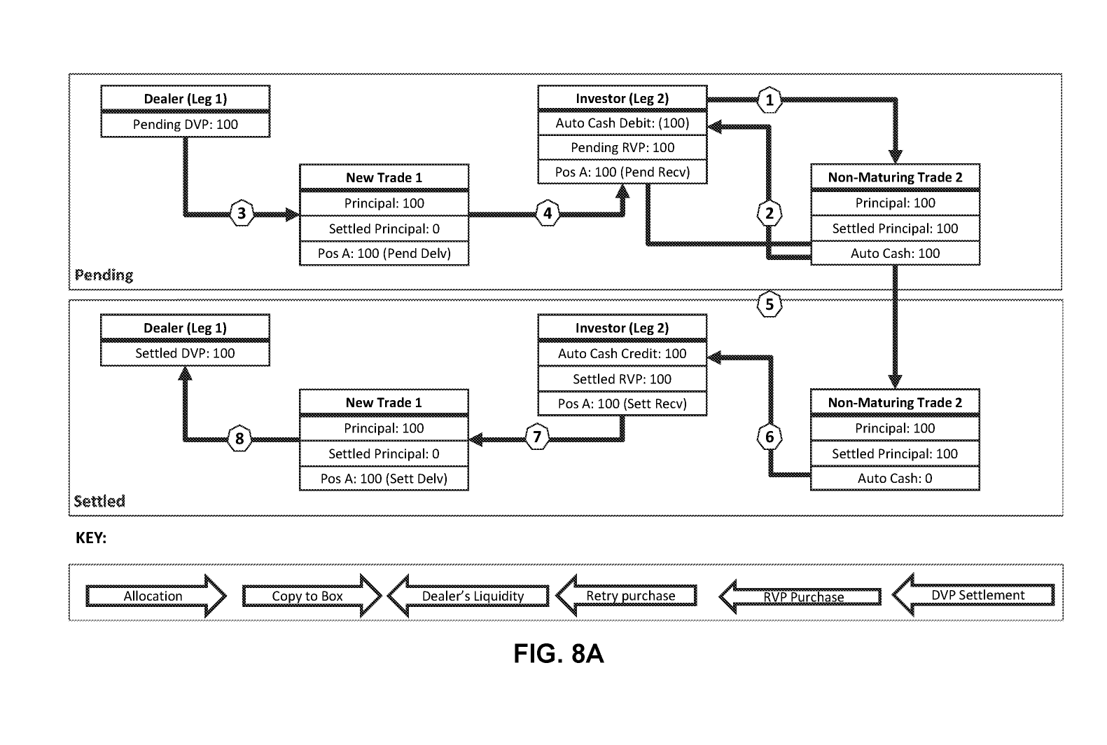

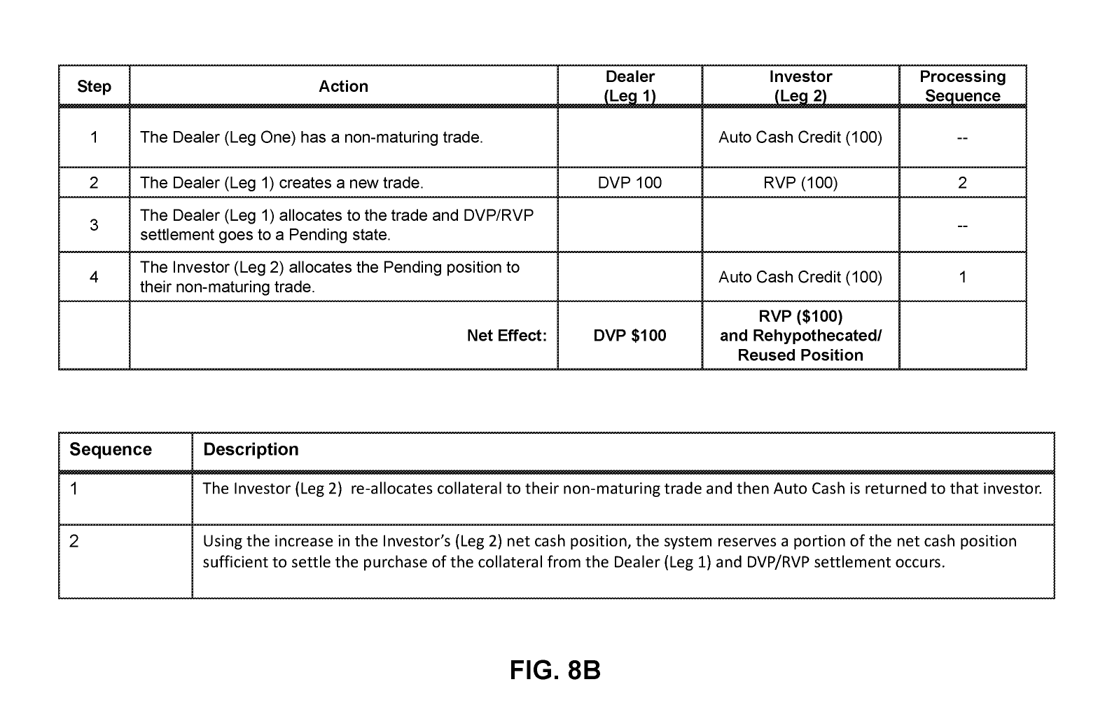

FIGS. 8A and 8B illustrate an exemplary process of the settlement flow of the dealer's purchase of real-time rehype collateral using liquidity from an investor's auto cash. In the diagram, the dealer has performed a release request, which has also substituted a position from the investor's trade against auto cash. The dealer then reallocates a new position to their trade, which pends to the investor. The investor then allocates the pending position to their trade. As a result of auto cash being this trade, the allocation triggers a return of auto cash, which can be used to offset the collateral purchase by the dealer.

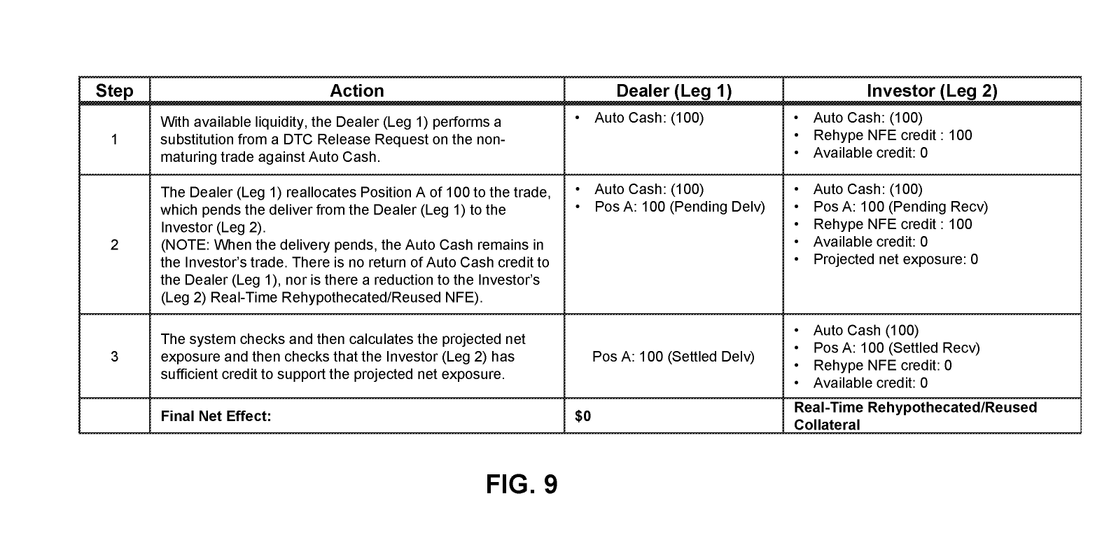

FIG. 9 illustrates an exemplary process of the settlement flow of a real-time rehype collateral purchase on a reallocation of collateral. Currently, when requesting collateral from a real-time rehype leg of a trade, the requesting leg and all downstream legs holding that position will receive an auto cash debit for the position released. When the dealer receives an auto cash debit from the substitution of a real-time rehype position, the subsequent downstream legs will also incur auto cash usage, which is offset with real-time rehype NFE (which is equal to the auto cash of the subsequent upstream leg.) However, in the present invention, when the same dealer that had performed the substitution of the real-time rehype position then reallocates the collateral back into the trade, the auto cash is removed from the trade and the subsequent downstream leg(s)' real-time rehype NFE is then reduced. The downstream leg still maintains the auto cash debit without a NFE credit offset. This mitigates this exposure by requiring investors to prefund their depository trust company (DTC) real-time rehype trades. When CLM enforcement is configured for the investor, the pre-funding requirement will not be necessary. The system will use the real-time rehype NFE credit to offset the exposure amount, and then the investor will be required to fund the difference.

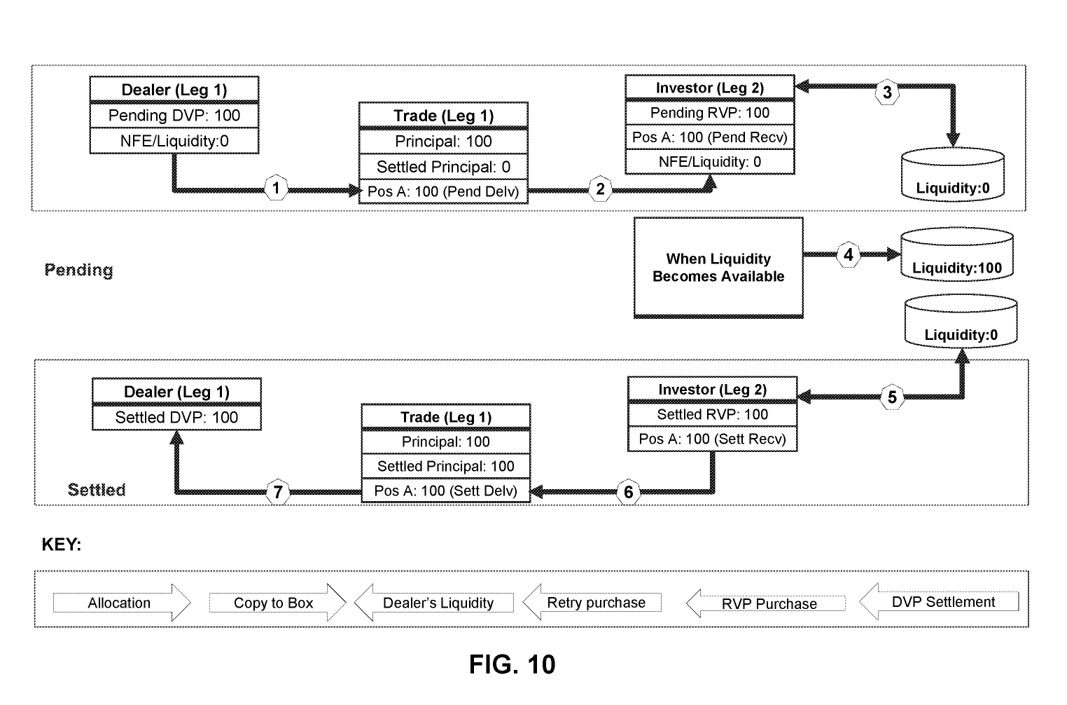

FIG. 10 illustrates an exemplary process of settling a real-time rehype collateral purchase through retry using the investor's available liquidity.

Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A method for real-time rehype, the method being implemented on a computer system having one or more physical processors programmed with computer program instructions which, when executed, perform the method, the method comprising:
allocating, by the computer system, a real-time rehype position to an investor;
pending, by the computer system, the position into a dealer box of the investor;
determining, by the computer system, the liquidity of the investor;
in response to the investor having insufficient liquidity, continue pending the position into a dealer box;
in response to the investor having sufficient liquidity, settling the position with the investor.

2. The method according to claim 1, further including:
delivering allocated collateral in a pending deliver position from the dealer; and
copying the collateral to the investor as a pending receive position.

3. The method according to claim 1, wherein determining the liquidity of the investor includes:
analyzing criteria of the investor to determine whether the investor can cover a predetermined threshold of the position.

4. The method according to claim 1, wherein pending the position into a dealer box includes:
checking the liquidity of the investor at regular intervals to determine the liquidity of the investor.

5. The method according to claim 1, wherein the positions are incrementally settled based on the investor's available liquidity investor.

6. The method according to claim 1, further including:
allocating a settled position and then a pending position in response to a position that has both pending and settled status.

7. The method according to claim 1, further including:
generating a report displaying positions that are completed, pending, and/or failed.

8. A system for real-time rehype comprising:
a computer system having one or more physical processors programmed with computer program instructions which, when executed, cause the computer system to:
allocate a real-time rehype position to an investor;
pend the position into a dealer box of the investor;
determine the liquidity of the investor;
in response to the investor having insufficient liquidity, continue pending the position into a dealer box;
in response to the investor having sufficient liquidity, settling the position with the investor.

9. The system according to claim 8, wherein the computer system is further programmed to:
deliver allocated collateral in a pending deliver position from the dealer; and
copy the collateral to the investor as a pending receive position.

10. The system according to claim 8, wherein determining the liquidity of the investor includes:
analyzing criteria of the investor to determine whether the investor can cover a predetermined threshold of the position.

11. The system according to claim 8, wherein pending the position into a dealer box includes:
checking the liquidity of the investor at regular intervals to determine the liquidity of the investor.

12. The system according to claim 8, wherein the positions are incrementally settled based on the investor's available liquidity investor.

13. The system according to claim 8, wherein the computer system is further programmed to:
allocate a settled position and then a pending position in response to a position that has both pending and settled status.

14. The system according to claim 8, wherein the computer system is further programmed to:
generate a report displaying positions that are completed, pending, and/or failed.
